(19) United States
(12) Patent Application Publication
(10) Pub. No.: US 2020/0194196 A1
(43) Pub. Date: Jun. 18, 2020

(54) HERMETICALLY SEALED OVER-MOLDED BUTTON ASSEMBLY

(71) Applicant: N2 Imaging Systems, LLC, Irvine, CA (US)

(72) Inventors: Iliyan Iliev, Irvine, CA (US); Jay Meyer, Snohomish, WA (US)

(21) Appl. No.: 16/217,557

(22) Filed: Dec. 12, 2018

(51) Int. Cl. H01H 13/06; H01H 9/04; H01H 13/14

(52) U.S. Cl. CPC H01H 13/063; H01H 2013/066; H01H 13/14; H01H 9/041

(57) ABSTRACT

A button assembly is disclosed including a plastic cover having an upper body portion and a lower flange portion, the upper body portion having a top wall and an interior cavity, wherein a port is formed in the top wall of the upper body portion and the lower flange portion is adapted and configured to be welded to a wall of a plastic housing, and an elastomeric button over-molded on the plastic cover and including an upper actuation portion and a lower body portion, wherein the upper actuation portion extends through the port formed in the top wall of the upper body portion of the cover, and the lower body portion resides in the interior cavity of the upper body portion of the cover.

### BACKGROUND OF THE INVENTION

### 1. Field of the Invention

The subject invention is directed to a button assembly, and more particularly, to a hermetically sealed over molded button assembly for activating an electronic switch of a communication device.

### 2. Description of Related Art

It is known in the art to use an adhesive to bond a rubber button to the plastic housing of a communication device for activating an electronic switch within the housing. Overtime, the edges of the rubber button can peel away from the plastic housing, leaving the electronic switch susceptible to the environment. Adhesive bonding is also a time consuming manufacturing technique. Accordingly, there is a need in the art for a more durable, externally sealed interface between a rubber button and a plastic housing that does not require adhesive bonding or any other type of fastener.

The subject invention overcomes the above-noted deficiencies of the prior art button assemblies by providing a rubber button that is over-molded on a plastic cover, which is then ultrasonically or laser welded to a plastic housing. This assembly process eliminates the need for adhesives and creates a durable seal from the environment by compressing the rubber button between the plastic cover and housing. The welding process provides a further improvement over the time consuming adhesive bonding process used in the prior art, because the button assembly of the subject invention is sealed immediately after the welding process is performed, rather than having to wait for the adhesive to bond.

### SUMMARY OF THE DISCLOSURE

The subject invention is directed to a new and useful button assembly for actuating an electronic switch, and more particularly, to a hermetically sealed over-molded button assembly for activating an electronic switch associated with a data communication system. The button assembly of the subject invention includes a plastic cover and an elastomeric button that is over-molded on the plastic cover, and then the plastic cover is mechanically attached a plastic housing, so that the rubber button is compressed between the cover and the housing, creating a robust structural seal between the button and the housing.

The plastic housing includes a wall having an exterior surface and an interior surface. The wall of the housing has an aperture extending therethrough from the exterior surface to the interior surface, and a raised ridge is formed on the exterior surface of the wall surrounding the aperture. The cover includes an upper body portion and a lower flange portion. The upper body portion has a top wall and an interior cavity. A port is formed in the top wall of the upper body portion of the cover.

The button includes an upper actuation portion and a lower body portion. The upper actuation portion of the button extends through the port formed in the top wall of the cover. The lower body portion of the button resides within the interior cavity of the upper body portion of the cover. The lower body portion of the button has an outer wall with a bottom surface having a channel for accommodating the raised ridge surrounding the aperture in the housing. The outer wall of the button includes a downwardly extending sealing lip for engaging an interior surface of the aperture formed in the wall of the housing. The outer wall of the button surrounds an interior actuation chamber and an actuation post extends downwardly from the actuation portion of the button within the interior actuation chamber for contacting a switch located below the interior surface of wall of the housing when the actuation portion of the button is depressed.

The subject invention is also directed to a button assembly that includes a plastic cover and an elastomeric button over-molded on the plastic cover. The plastic cover includes an upper body portion having a top wall and an interior cavity. A port is formed in the top wall of the upper body portion and the lower flange portion is adapted and configured to be welded to a wall of a plastic housing. The elastomeric button includes an upper actuation portion and a lower body portion. The upper actuation portion extends through the port formed in the top wall of the upper body portion of the cover, and the lower body portion resides in the interior cavity of the upper body portion of the cover.

Preferably, the lower body portion of the button includes an outer wall having a bottom surface with a channel for accommodating a raised ridge surrounding an aperture formed in the wall of the housing and a downwardly extending sealing lip for engaging an interior surface of the aperture. Preferably, the outer wall of the lower body portion of the button surrounds an interior actuation chamber and an actuation post extends downwardly from the actuation portion of the button within the interior actuation chamber for contacting a switch located below an interior surface of the wall of the housing when the actuation portion of the button is depressed.

The subject invention is also directed to a method of constructing a button assembly, which includes the steps of providing a plastic cover, providing or otherwise over-molding an elastomeric button on the plastic cover, and mechanically attaching the plastic cover to a plastic housing by ultrasonic or laser welding.

These and other features of the hermetically sealed over-molded button assembly of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those having ordinary skill in the art will readily understand how to make and use the hermetically sealed over-molded button assembly of the subject invention without undue experimentation, preferred embodiments thereof will be described in detail herein below with reference to the figures wherein:

FIG. 1 is a perspective view of the hermetically sealed over-molded button assembly of the subject invention;

FIG. 2 is an exploded perspective view of the button assembly of FIG. 1, with parts separate for ease of illustration;

FIG. 3 is a cross-sectional view of the button assembly of the subject invention taken along line 3-3 of FIG. 1; and

FIG. 4 is an enlarged localized cross-sectional view from FIG. 3.

### DETAILED DESCRIPTION OF THE PREFERRED EMBODIMENTS

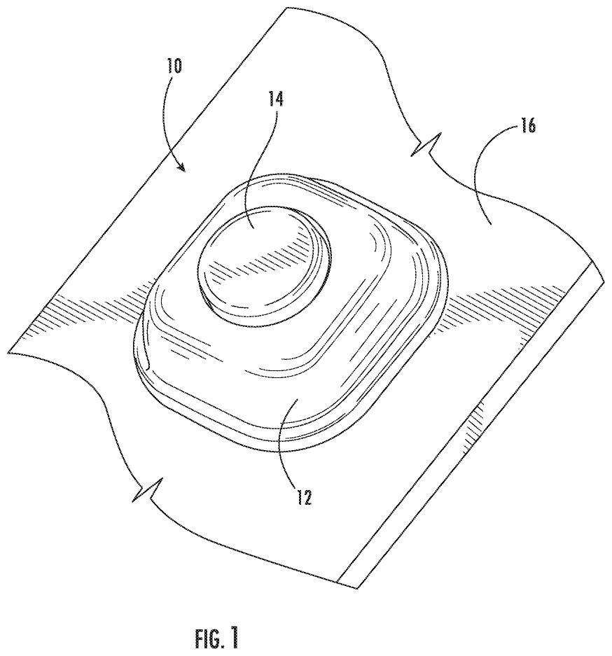

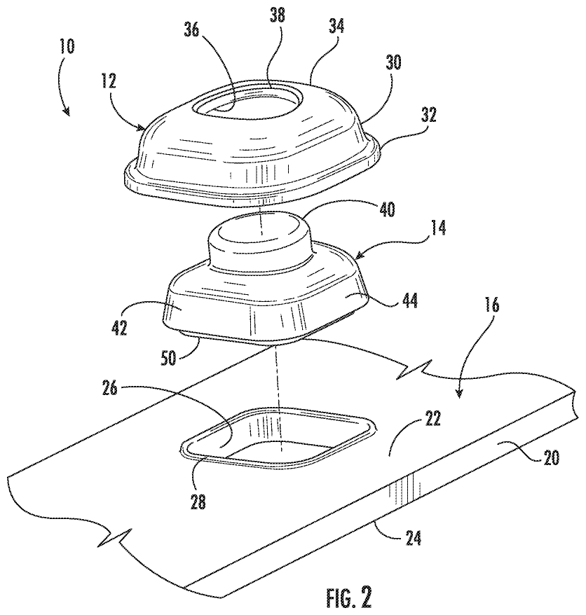

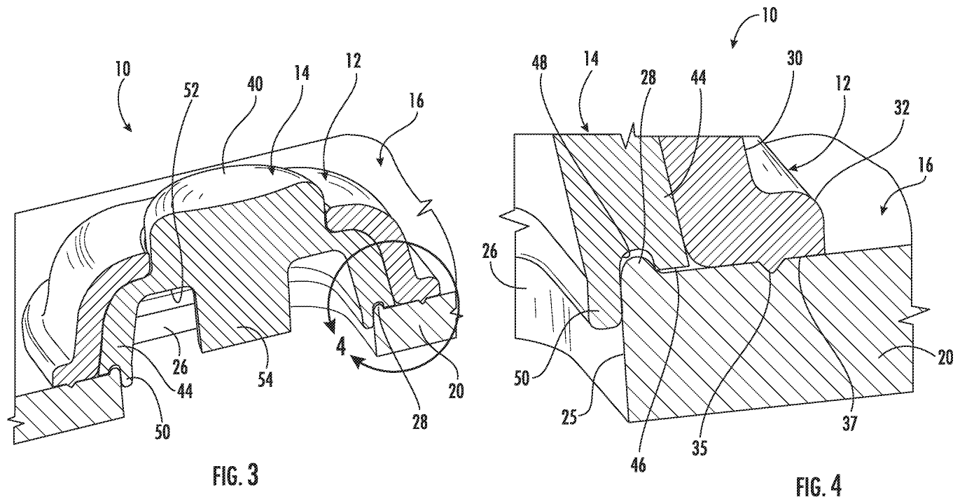

Referring now to the drawings wherein like reference numerals identify similar structural elements or features of the subject invention, there is illustrated in FIG. 1 a new and useful button assembly for actuating an electronic switch, and more particularly, to a hermetically sealed over-molded button assembly for activating an electronic switch associated with a communication device such as, for example a thermally enhanced night vision goggle system, as disclosed in commonly assigned U.S. Pat. No. 9,705,605, the disclosure of which is herein incorporated by reference

The button assembly 10 of the subject invention includes a thermoplastic cover 12 and an elastomeric or rubber button 14 that is over-molded on the thermoplastic cover 12 (i.e., the substrate). The thermoplastic cover 12 is then mechanically attached to a thermoplastic housing 16 by ultrasonic or laser welding. As a result of this joining process, the rubber button 14 is advantageously compressed between the cover 12 and the housing 16. This creates a robust structural seal between the rubber button 14 and the plastic housing 16. Moreover, a durable, externally sealed interface is formed between the rubber button 14 and the plastic housing 16 that protects electronic components in the housing from the environment and does not require adhesive bonding.

The plastic housing 16 includes an outer wall 20 having an exterior surface 22 and an interior surface 24. The wall 20 of the plastic housing 16 has an aperture 26 that extends through the wall 20 from the exterior surface 22 thereof to the interior surface 24 thereof. A raised ridge 28 is formed on the exterior surface 22 of the wall 20 surrounding the periphery of the aperture 26.

The thermoplastic cover 12 of the button assembly 10 includes an upper body portion 30 and a lower flange portion 32. The upper body portion 30 of the cover 12 has a top wall 34 and an interior cavity 36. A circular port or aperture 38 is formed in the top wall 32 of the upper body portion 30 of the cover 12. Integral weldment assistance structure 35 is provided on a contacting surface 37 of the lower flange portion 32, for interacting with the exterior surface 22 of the plastic housing 16 during fabrication.

The rubber button 14 of the button assembly 10 includes an upper actuation portion 40 and a lower body portion 42. The upper actuation portion 40 of the rubber button 14 extends through the port 38 formed in the top wall 32 of the plastic cover 12. The lower body portion 42 of the button 14 resides within the interior cavity 36 of the upper body portion 30 of the cover 12. The lower body portion 42 of the button 14 has an outer wall 44 with a bottom surface 46 having a channel 48 for accommodating and compressing the raised ridge 28 surrounding the aperture 26 in the housing 16.

The outer wall 44 of the button 14 includes a downwardly extending radially inner sealing lip 50 for engaging an interior surface 25 of the aperture 26 formed in the wall 20 of the housing 16. This interface hermetically seals the aperture 26 from the environment, protecting electronic components located within the housing 16.

The outer wall 44 of the button 14 surrounds an interior actuation chamber 52 and an actuation post 54 extends downwardly from the upper actuation portion 40 of the button 14 within the interior actuation chamber 52 for contacting a switch located on a PCB below the interior surface 24 of wall 20 of the housing 16, when the upper actuation portion 40 of the button 14 is depressed.

In sum, the subject invention describes a method of constructing a button assembly 10, which includes the steps of providing a thermoplastic cover 12 (the substrate), over-molding an thermoplastic elastomer (TPE) button 14 on the thermoplastic cover 12, and mechanically attaching the thermoplastic cover 12 to a thermoplastic housing 16 by ultrasonic or laser welding.

While the subject disclosure has been shown and described with reference to preferred embodiments, those skilled in the art will readily appreciate that changes and/or modifications may be made thereto without departing from the scope of the subject disclosure.

For example, while the over-molded button assembly 10 of the subject invention has been discussed in association with a communication system, those skilled in the art will readily appreciate that the over-molded button assembly 10 can be utilized with any type of electronic device that has a thermoplastic housing.

In addition, while the over-molded button assembly 10 and the aperture 26 provided in the housing 16 are shown and described as having a generally rectangular or square configuration, the button assembly and the aperture could be configured in virtually any shape, such as, for example, circular, oblong or oval, as dictated by design.

What is claimed is:

1. A button assembly comprising:
a) a plastic cover; and
b) an elastomeric button over-molded on the plastic cover.

2. A button assembly as recited in claim 1, wherein the plastic cover is mechanically attached to a plastic housing.

3. A button assembly as recited in claim 2, wherein the plastic cover is mechanically attached to the plastic housing by ultrasonic or laser welding.

4. A button assembly as recited in claim 2, wherein the plastic housing includes a wall having an exterior surface and an interior surface, and wherein the wall has an aperture extending therethrough from the exterior surface to the interior surface.

5. A button assembly as recited in claim 4, wherein a raised ridge is formed on the exterior surface of the wall surrounding the aperture.

6. A button assembly as recited in claim 5, wherein the cover includes an upper body portion and a lower flange portion, the upper body portion having a top wall and an interior cavity.

7. A button assembly as recited in claim 6, wherein a port is formed in the top wall of the upper body portion of the cover.

8. A button assembly as recited in claim 7, wherein the button includes an upper actuation portion and a lower body portion.

9. A button assembly as recited in claim 8, wherein the upper actuation portion of the button extends through the port formed in the top wall of the cover.

10. A button assembly as recited in claim 9, wherein the lower body portion of the button resides within the interior cavity of the upper body portion of the cover.

11. A button assembly as recited in claim 10, wherein the lower body portion of the button has an outer wall with a bottom surface having a channel for accommodating the raised ridge surrounding the aperture in the housing.

12. A button assembly as recited in claim 11, wherein the outer wall of the button includes a downwardly extending sealing lip for engaging an interior surface of the aperture formed in the wall of the housing,

13. A button assembly as recited in claim 12, wherein the outer wall of the button surrounds an interior actuation chamber and an actuation post extends downwardly from the actuation portion of the button within the interior actuation chamber for contacting an electronic switch located below the interior surface of wall of the housing when the actuation portion of the button is depressed.

14. A button assembly comprising:
a) a plastic cover including an upper body portion and a lower flange portion, the upper body portion of the cover having a top wall and an interior cavity, wherein a port is formed in the top wall of the upper body portion and the lower flange portion is adapted and configured to be welded to an exterior wall of a plastic housing; and
b) an elastomeric button over-molded on the plastic cover and including an upper actuation portion and a lower body portion, wherein the upper actuation portion extends through the port formed in the top wall of the upper body portion of the cover, and the lower body portion resides in the interior cavity of the upper body portion of the cover.

15. A button assembly as recited in claim 14, wherein the lower body portion of the button includes an outer wall having a bottom surface with a channel for accommodating a raised ridge surrounding an aperture formed in the wall of the housing and a downwardly extending sealing lip for engaging an interior surface of the aperture.

16. A button assembly as recited in claim 15, wherein the outer wall of the lower body portion of the button surrounds an interior actuation chamber and an actuation post extends downwardly from the actuation portion of the button within the interior actuation chamber for contacting an electronic switch located below an interior surface of the wall of the housing when the actuation portion of the button is depressed.

17. A method of constructing a button assembly comprising:
a) providing a plastic cover;
b) providing an elastomeric button on the plastic cover; and
c) mechanically attaching the plastic cover to the plastic housing.

18. A method according to claim 17, wherein the step of providing an elastomeric button on the plastic cover involves over-molding the elastomeric button on the plastic cover.

19. A method according to claim 17, wherein the step of mechanical attaching the plastic cover to the plastic housing involves ultrasonic welding.

20. A method according to claim 17, wherein the step of mechanical attaching the plastic cover to the plastic housing involves laser welding.
